(19) United States
(12) Patent Application Publication
(10) Pub. No.: US 2026/0158308 A1
(43) Pub. Date: Jun. 11, 2026

(54) ELECTRIC BUS FIRE EXTINGUISHING APPARATUS CAPABLE OF BEING LOADED AND UNLOADED BY HYDRAULIC CYLINDER

(71) Applicant: TANKTECH CO., LTD., Busan (KR)

(72) Inventors: Tae Ho JI, Busan (KR); Sun Jae KIM, Busan (KR); Joo Ha AN, Busan (KR); Young Han KIM, Busan (KR); Han Ki BAEK, Busan (KR); Deok Won KIM, Busan (KR)

(21) Appl. No.: 19/179,973

(22) Filed: Apr. 15, 2025

(30) Foreign Application Priority Data
Sep. 6, 2024 (KR) 10-2024-0121934

(51) Int. Cl. A62C 3/07; A62C 3/16

(52) U.S. Cl. CPC A62C 3/07; A62C 3/16

(57) ABSTRACT

Proposed is an electric bus fire extinguishing apparatus capable of being loaded and unloaded by a hydraulic cylinder. The electric bus fire extinguishing apparatus includes a rotation assisting plate mounted on a rear side of a loading container of a transporting vehicle, a hydraulic cylinder disposed in the loading container of the transporting vehicle, a foldable frame configured to be unfolded and folded by hydraulic pressure, a support stand which is disposed on a first side of the foldable frame and configured to be locked on and coupled to a cylinder rod that is pulled from the hydraulic cylinder, and a lance for spraying fire-extinguishing water, the lance being configured to perforate a battery disposed on an upper portion of an electric bus and to spray the fire-extinguishing water into an inner portion of the battery.

### CROSS REFERENCE TO RELATED APPLICATION

The present application claims priority to Korean Patent Application No. 10-2024-0121934, filed Sep. 6, 2024, the entire contents of which are incorporated herein for all purposes by this reference.

### BACKGROUND

### Technical Field

The present disclosure relates to an electric bus fire extinguishing apparatus capable of being loaded and unloaded by a hydraulic cylinder. More particularly, the present disclosure relates to an electric bus fire extinguishing apparatus capable of being loaded and unloaded by a hydraulic cylinder, the electric bus fire extinguishing apparatus being capable of conveniently loaded on and unloaded from a transporting vehicle through the hydraulic cylinder, and the electric bus fire extinguishing apparatus being configured to perforate a battery disposed on an upper portion of an electric bus where a fire occurs and to spray fire-extinguishing water into the battery by hydraulic pressure while the electric bus fire extinguishing apparatus is in close contact with the electric bus, thereby being capable of rapidly extinguishing the fire.

### Description of the Related Art

Recently, in a situation in which the number of registered electric vehicles in Korea is gradually increasing and major public transportation such as taxis and buses are also changing to electric vehicles, it is becoming an urgent problem to prepare safety measures in response to electric vehicle fires, such as frequent fires and not easily extinguished due to the characteristics of electric vehicle batteries.

Particularly, in an electric bus, a battery storing a high capacity of energy is disposed on an upper portion of the electric bus. When a battery ignites due to an accident or various other reasons, the temperature of the heating point is very high and a continuous thermal transfer due to a high-density integrated form occurs, so that it is difficult to extinguish the fire.

When a fire occurs in a battery of an electric bus, the fire is not extinguished easily and is easily reignited until the battery is completely burned. Therefore, there is a difficulty in extinguishing the fire since a large amount of fire-extinguishing water is required to be sprayed for a long time.

The most effective fire extinguishing method to solve this problem is a method in which an electric vehicle in which a fire occurs is lifted by a crane and is contained in a water tank filled with water, but there is a problem that such a method is difficult to be applied in an electric bus due to the weight and the size of the electric bus.

### SUMMARY

Accordingly, the present disclosure has been made keeping in mind the above problems occurring in the related art, and an objective of the present disclosure is to provide an electric bus fire extinguishing apparatus capable of being loaded and unloaded by a hydraulic cylinder, the electric bus fire extinguishing apparatus being capable of conveniently loaded on and unloaded from a transporting vehicle through the hydraulic cylinder, and the electric bus fire extinguishing apparatus being configured to perforate a battery disposed on an upper portion of an electric bus where a fire occurs and to spray fire-extinguishing water into the battery by hydraulic pressure while the electric bus fire extinguishing apparatus is in close contact with the electric bus, thereby being capable of rapidly extinguishing the fire.

According to an aspect of the present disclosure, there is provided an electric bus fire extinguishing apparatus capable of being loaded and unloaded by a hydraulic cylinder, the electric bus fire extinguishing apparatus including: a rotation assisting plate 110 mounted on a rear side of a loading container of a transporting vehicle; a hydraulic cylinder 120 disposed in the loading container of the transporting vehicle; a foldable frame 130 configured to be unfolded and folded by hydraulic pressure; a support stand 140 disposed on a first side of the foldable frame 130 and configured such that a first side of the support stand 140 is locked on and coupled to an end portion of a cylinder rod 121 that is pulled from the hydraulic cylinder 120; and a lance 150 for spraying fire-extinguishing water, the lance 150 being disposed on the foldable frame 130, and the lance 150 being configured to perforate a battery disposed on an upper portion of an electric vehicle and to spray the fire-extinguishing water supplied from a fire-extinguishing water tank mounted in the transporting vehicle into an inner portion of the battery, wherein, in a state in which the support stand 140 is locked on and coupled to the end portion of the cylinder rod 121, the support stand 140 is seated on the rotation assisting plate 110 and a state in which the support stand 140 is loaded on the transporting vehicle is maintained, and wherein, when the cylinder rod 121 is pulled, the support stand 140 is moved toward a ground surface by being slidably moved while the support stand 140 is in a state in which the support stand 140 is in close contact with the rotation assisting plate 110, and the support stand 140 is released from the end portion of the cylinder rod 121, so that the support stand 140 and the rotation assisting plate 110 are separated from each other and then unloading is finished.

According to an aspect of the present disclosure, the rotation assisting plate 110 may include: a base plate 111 disposed on a rear side of a bottom surface of the loading container; a mounting round bar 112 which is disposed on an upper side of the base plate 111 and on which the support stand 140 is mounted; and a locking and coupling mechanism 113 disposed on the upper side of the base plate 111 such that the locking and coupling mechanism 113 is spaced apart from the mounting round bar 112 by a predetermined distance, the locking and coupling mechanism 113 being configured such that the first side of the support stand 140 is locked on and coupled to the locking and coupling mechanism 113 while the support stand 140 is in a state in which the support stand 140 is seated on the mounting round bar 112.

According to an aspect of the present disclosure, the foldable frame 130 may include: a lower frame 131; an upper frame 132 to the lower frame 131 by a hinge such that a first side of the upper frame 132 is capable of being rotated; a folding cylinder 133 connected to the lower frame 131 and the upper frame 132 by being positioned between the lower frame 131 and the upper frame 132, the folding cylinder 133 being configured to control a rotation of the upper frame 132 by hydraulic pressure; an upper fixing frame 134 coupled to the upper frame 132 by a hinge such that a first side of the upper fixing frame 134 is capable of being rotated, the upper fixing frame 134 being configured to be brought into close contact with an upper surface of the electric bus; an upper fixing cylinder 135 connected to the upper frame 132 and the upper fixing frame 134 by being positioned between the upper frame 132 and the upper fixing frame 134, the upper fixing cylinder 135 being configured to control a rotation of the upper fixing frame 134 by hydraulic pressure; a lower fixing frame 136 coupled to the lower frame 131 by a hinge such that a first side of the lower fixing frame 136 is capable of being rotated, the lower fixing frame 136 being configured to be brought into close contact with a lower surface of the electric bus; a lower fixing cylinder 137 connected to the lower frame 131 and the lower fixing frame 136 by being positioned between the lower frame 131 and the lower fixing frame 136, the lower fixing cylinder 137 being configured to control a rotation of the lower fixing frame 136 by hydraulic pressure; and a perforating cylinder 138 disposed on an end portion of the upper fixing frame 134, the perforating cylinder 138 being configured to push the lance 150 for spraying the fire-extinguishing water positioned above the electric bus toward the battery.

According to an aspect of the present disclosure, the folding cylinder 133, the upper fixing cylinder 135, the lower fixing cylinder 137, and the perforating cylinder 138 may be connected to a hydraulic pump 200 disposed on a first side of the transporting vehicle through a hydraulic pressure supply line, and may be controlled by hydraulic pressure.

According to an aspect of the present disclosure, the support stand 140 may be disposed on a first side of the lower frame 131, may have a predetermined length, and may be configured to be slidably moved on the mounting round bar 112 while being in a state in which the support stand 140 is seated on the mounting round bar 112.

According to an aspect of the present disclosure, the support stand 140 may include: a rotation locking step 141 for rotating the support stand 140 at 90 degrees by allowing the first side of the support stand 140 to be caught on the mounting round bar 112 during a process of sliding the support stand 140 on the mounting round bar 112 while the support stand 140 is in a state in which the support stand 140 is seated on the mounting round bar 112 while the unloading is performed; and a rotation limitation round bar 142 configured to be locked on and coupled to the locking and coupling mechanism 113 so as to prevent the rotation of the support stand 140 while loading is performed.

According to an aspect of the present disclosure, the lance 150 for spraying the fire-extinguishing water may be configured to receive the fire-extinguishing water by being coupled to a fire-extinguishing water pump 300 disposed on a first side of the fire-extinguishing water tank through a fire-extinguishing water supply line.

According to an aspect of the present disclosure, the lance 150 for spraying the fire-extinguishing water may include: a lance head 151 configured to perforate an upper portion of the battery by hydraulic pressure; and a fire-extinguishing water nozzle 152 formed on a side surface of a body of the lance 150 for spraying the fire-extinguishing water, the fire-extinguishing water nozzle 152 being configured to spray the fire-extinguishing water to the outside, and wherein the lance head 151 may be connected to the lance 150 for spraying the fire-extinguishing water such that the lance head 151 is capable of being replaced from the body of the lance 150 for spraying the fire-extinguishing water.

According to an aspect of the present disclosure, the body of the lance 150 for spraying the fire-extinguishing water may be formed as a multi-stage body, and the fire-extinguishing water nozzle 152 may be disposed on each stage of the body.

According to an aspect of the present disclosure, the perforating cylinder 138 and the lance 150 for spraying the fire-extinguishing water may be configured such that a direction of the perforating cylinder 138 and the lance 150 for spraying the fire-extinguishing water is capable of being switched by releasing a bolt from the end portion of the upper fixing frame 134.

According to the present disclosure, there is an advantage that loading and unloading of the electric bus fire extinguishing apparatus to the transporting vehicle is conveniently performed by the hydraulic cylinder.

In addition, according to the present disclosure, since the direction of the perforating cylinder and the lance for spraying the fire-extinguishing water is capable of being conveniently switched by releasing the bolt, the battery of the electric bus that is tipped sideways is capable of being perforated and the fire-extinguishing water is capable of being sprayed into the battery, so that there is an advantage that the fire is capable of being rapidly extinguished.

In addition, according to the present disclosure, since the battery disposed on the upper portion of the electric bus is perforated by hydraulic pressure and the fire-extinguishing water is injected into the battery while the electric bus fire extinguishing apparatus is in close contact with the electric bus in which the fire occurs, there is an advantage that the fire is capable of being rapidly extinguished.

In addition, according to the present disclosure, since the foldable structure is applied to the electric bus fire extinguishing apparatus, there are advantages that the volume of the electric bus fire extinguishing apparatus is capable of being minimized and the electric bus fire extinguishing apparatus is capable of being easily and conveniently transported to a fire site.

In addition, according to the present disclosure, since the electric bus fire extinguishing apparatus is brought into close contact with the upper and lower surfaces of the electric bus and is solidly fixed to the electric bus, the lance for spraying the fire-extinguishing water is not separated from the electric bus during the process of spraying the high-pressure fire-extinguishing water into the inner portion of the battery by hydraulic pressure, so that there is an advantage that the fire is stably extinguished.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view schematically illustrating an overall configuration of an electric bus fire extinguishing apparatus 100 capable of being loaded and unloaded by a hydraulic cylinder according to an embodiment of the present disclosure;

FIG. 2 is a view illustrating a state in which the electric bus fire extinguishing apparatus 100 capable of being loaded and unloaded by the hydraulic cylinder illustrated in FIG. 1 is loaded on a transporting vehicle;

FIG. 3 is a view illustrating a configuration of a rotation assisting plate 110 in more detail;

FIG. 4 is a view illustrating a configuration of a foldable frame 130 in more detail;

FIG. 5A and FIG. 5B are views illustrating a state in which an upper frame 132 is rotated from a lower frame 131 by a folding cylinder 133.

FIG. 6A and FIG. 6B are views illustrating a state in which an upper fixing frame 134 and a lower fixing frame 136 are respectively rotated from the upper frame 132 and the lower frame 131 by an upper fixing cylinder 135 and a lower fixing cylinder 137 and are respectively brought into close contact with an upper portion and a lower portion of an electric bus;

FIG. 7A and FIG. 7B are views illustrating a state in which a lance 150 for spraying fire-extinguishing water is inserted toward an inner portion of a battery and perforates the battery by a perforating cylinder 138;

FIG. 8 is a view illustrating a configuration of a support stand 140 in more detail;

FIG. 9A and FIG. 9B are views illustrating a process in which the foldable frame 130 is unloaded from the transporting vehicle by pulling a cylinder rod 121;

FIG. 10A and FIG. 10B are views illustrating the lance 150 for spraying the fire-extinguishing water in more detail; and

FIG. 11 is a view illustrating a state in which the lance 150 for spraying the fire-extinguishing water is inserted toward the inner portion of the battery and perforates the battery from a side surface of the electric bus that is tipped sideways.

### DETAILED DESCRIPTION

Hereinafter, an embodiment of the present disclosure will be described in detail with reference to the accompanying drawings. However, in describing the present disclosure, detailed explanations of relevant functions or components that are publicly known are omitted, if it is deemed that such detailed explanations may unnecessarily obscure the essence of the present disclosure.

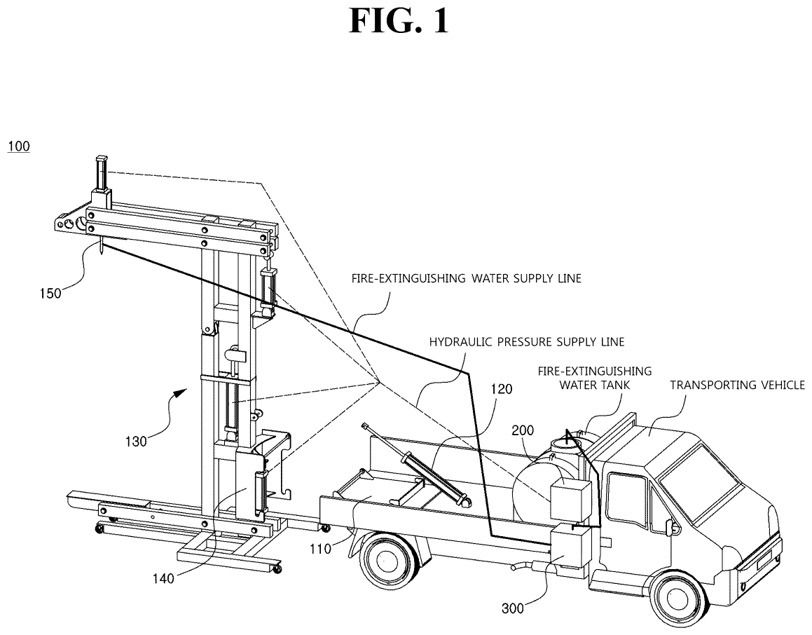

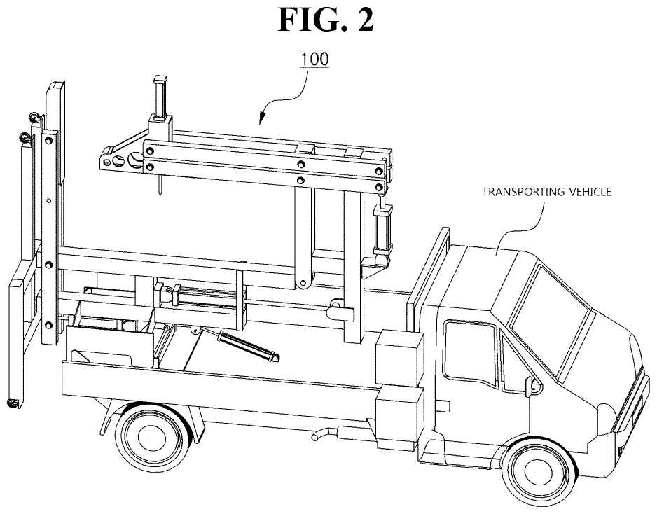

FIG. 1 is a view schematically illustrating an overall configuration of an electric bus fire extinguishing apparatus 100 capable of being loaded and unloaded by a hydraulic cylinder according to an embodiment of the present disclosure, and FIG. 2 is a view illustrating a state in which the electric bus fire extinguishing apparatus 100 capable of being loaded and unloaded by the hydraulic cylinder illustrated in FIG. 1 is loaded on a transporting vehicle.

Referring to FIG. 1 and FIG. 2, according to an embodiment of the present disclosure, the electric bus fire extinguishing apparatus 100 capable of being loaded and unloaded by the hydraulic cylinder may include a rotation assisting plate 110, a hydraulic cylinder 120, a foldable frame 130, a support stand 140, and a lance 150 for spraying fire-extinguishing water.

Here, a fire-extinguishing water tank may be mounted in a loading container of a transporting vehicle (for example, a truck and so on).

The fire-extinguishing water tank is a tank configured to accommodate the fire-extinguishing water for extinguishing a fire that occurs in a battery of an electric bus, a storage capacity of the fire-extinguishing water tank is not limited, and the fire-extinguishing water tank is capable of being transported to a fire site together with the foldable frame 130 by being loaded on the transporting vehicle.

The size or the volume of such a fire-extinguishing water tank is capable of being modified according to the loading capacity of the transporting vehicle. For example, a tank having a capacity of 1 ton may be applied.

In addition, according to an embodiment, a fire-extinguishing water pump 300 may be disposed on a first side of the fire-extinguishing water tank. The fire-extinguishing water pump 300 is configured to supply the fire-extinguishing water accommodated in the fire-extinguishing water tank to the lance 150 for spraying the fire-extinguishing water, and may generate a sufficient hydraulic pressure so that the fire-extinguishing water is capable of being strongly sprayed into the inner portion of the battery positioned on an upper side of the electric bus.

In addition, according to an embodiment, the fire-extinguishing water tank, the fire-extinguishing water pump 300, and the lance 150 for spraying the fire-extinguishing water may be connected to each other through a fire-extinguishing water supply line. The fire-extinguishing water supply line may be formed such that the-extinguishing water supply line has a sufficient length (for example, 10 m) so that the fire-extinguishing water supply line reaches the lance 150 for spraying the fire-extinguishing water.

In addition, according to an embodiment, a heat-resistant material may be applied to the fire-extinguishing water supply line so that the fire-extinguishing water supply line is not melted by a high-temperature heat generated from the battery positioned on the upper side of the electric bus, or heat-dissipation coating may be applied to an outer side of the fire-extinguishing water supply line.

In addition, although not illustrated in the drawings, according to an embodiment, the fire-extinguishing water supply line may be transported in a state in which the fire-extinguishing water supply line is wound in a circular shape through a winch, and may be automatically unwound when the foldable frame 130 that will be described later is separated from the transporting vehicle and the foldable frame 130 is transported to the electric bus.

The rotation assisting plate 110 is mounted on a rear side of the loading container of the transporting vehicle. Furthermore, the rotation assisting plate 110 may serve to fix the foldable frame 130 such that the foldable frame 130 is not separated when the foldable frame 130 is transported by the transporting vehicle, and may serve to guide the support stand 140 to be seated and rotated when the support stand 140 is unloaded. This is described in more detail below.

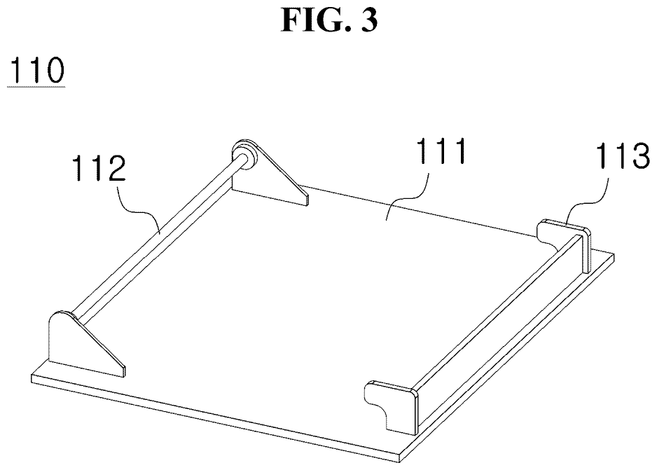

FIG. 3 is a view illustrating a configuration of the rotation assisting plate 110 in more detail.

Referring to FIG. 3, the rotation assisting plate 110 may include a base plate 111 disposed on a rear side of a bottom surface of the loading container, a mounting round bar 112 which is disposed on an upper side of the base plate 111 and on which the support stand 140 is seated, and a locking and coupling mechanism 113 which is disposed on the upper side of the base plate 111 such that the mounting round bar 112 is spaced apart from the locking and coupling mechanism 113 by a predetermined distance and to which a first side of the support stand 140 is locked on and coupled to the locking and coupling mechanism 113 while the support stand 140 is in a state in which the support stand 140 is seated on the mounting round bar 112.

The base plate 111 may be solidly mounted on the rear side of the bottom surface of the loading container of the transporting vehicle, and the mounting round bar 112 and the locking and coupling mechanism 113 may be disposed on the upper side of the base plate 111 such that the mounting round bar 112 and the locking and coupling mechanism 113 are spaced apart from each other by the predetermined distance.

At this time, the mounting round bar 112 may serve as a seating space on which the support stand 140 that will be described later is seated, and may serve as a rotary shaft for rotating the support stand 140 to be rotated at 90 degrees during the loading or unloading process.

The locking and coupling mechanism 113 is formed such that a cross-sectional area of the locking and coupling mechanism 113 has a “L” shape so that the first side of the support stand 140 that will be described later is capable of being locked on and coupled to the locking and coupling mechanism 113. Since the support stand 140 is locked on and coupled to the locking and coupling mechanism 113 in a state in which the foldable frame 130 is loaded on the transporting vehicle, the support stand 140 is capable of being maintained in a solidly fixed state and is not separated from the rotation assisting plate 110. This will be described later.

After the foldable frame 130 is transported to the fire site while being mounted on the transporting vehicle, the foldable frame 130 is capable of being separated from the transporting vehicle and is capable of being brought into close contact with the electric bus. Furthermore, the foldable frame 130 may be maintained in a folded state normally, and may be unfolded by hydraulic pressure. This will be described in more detail below.

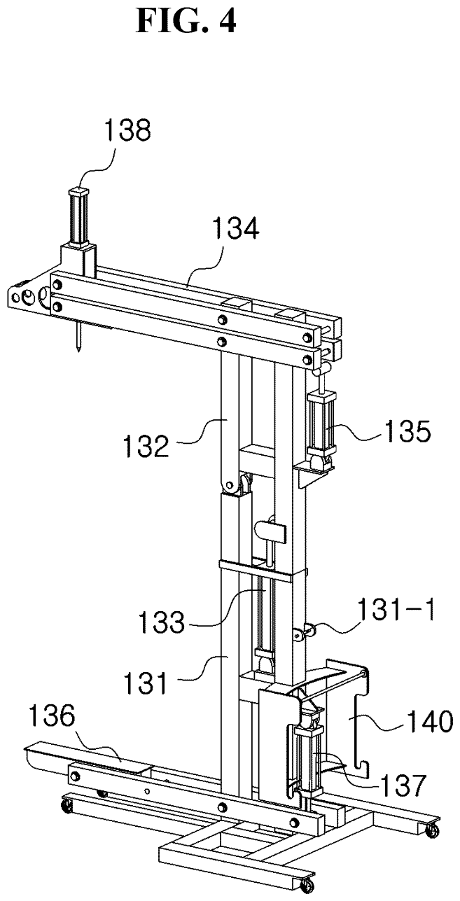

FIG. 4 is a view illustrating a configuration of the foldable frame 130 in more detail.

Referring to FIG. 4, the foldable frame 130 may be divided into a lower frame 131 that is seated on the bottom surface and an upper frame 132 that is coupled to the lower frame 131 by a hinge such that the upper frame 132 is capable of being rotated.

More specifically, the lower frame 131 is seated on the bottom surface and serves to support the foldable frame 130 such that the foldable frame 130 does not fall, and a plurality of wheels for facilitating a movement of the foldable frame 130 may be disposed on a lower side of the lower frame 131.

In addition, according to an embodiment, the hinge for rotating the upper frame 132 may be disposed on an upper side of the lower frame 131, so that the upper frame 132 is capable of being rotated from the lower frame 131 by the hinge and is capable of standing upright upward. This is to minimize the volume of the foldable frame 130 by folding the upper frame 132 during a normal state or during transporting the foldable frame 130, and is to increase the height of the foldable frame 130 to the height of the electric vehicle by rotating the upper frame 132 from the lower frame 131 during the process of preparing to extinguish a fire.

The upper frame 132 has a length equal to or smaller than a length of the lower frame 131 described above, and has a structure in which the upper frame 132 is rotated upward and unfolded from the lower frame 131 by the hinge or is rotated downward and folded.

Such an upper frame 132 may be rotated by hydraulic pressure from the lower frame 131 by a folding cylinder 133, which will be described below.

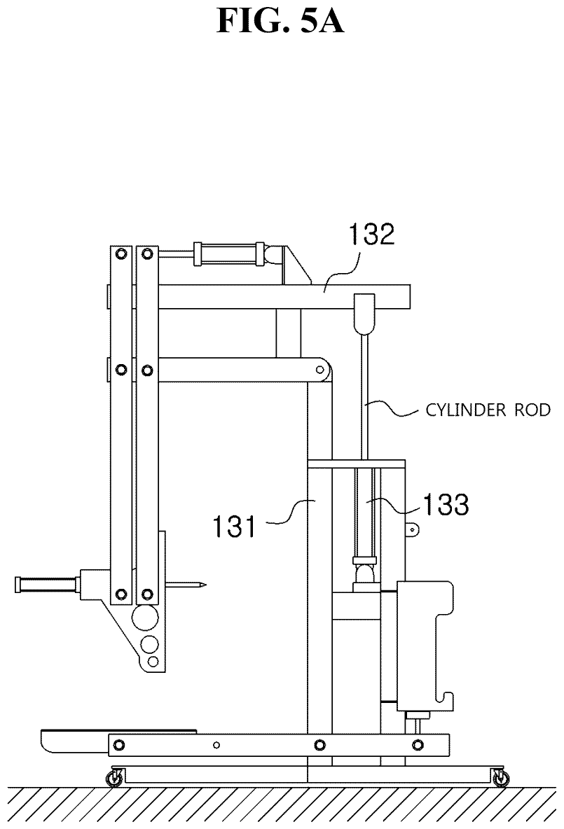

FIG. 5A and FIG. 5B are views illustrating a state in which the upper frame 132 is rotated from the lower frame 131 by the folding cylinder 133.

Referring to FIG. 5A and FIG. 5B, the lower frame 131 and the upper frame 132 are connected to each other by the hinge, and the lower frame 131 and the upper frame 132 are connected to each other by the folding cylinder 133. A hydraulic cylinder is applied in the folding cylinder 133. Therefore, the folding cylinder 133 is capable of standing the upper frame 132 upright by reducing a length of a cylinder through hydraulic pressure, or is capable of folding the upper frame 132 downward by increasing the length of the cylinder. Such a folding cylinder 133 is connected to a hydraulic pump 200 that is disposed on a first side of the transporting vehicle through a hydraulic pressure supply line, and may be controlled by hydraulic pressure.

Here, the hydraulic pump 200 is connected to the folding cylinder 133 through the high-pressure hydraulic pressure supply line, and is configured to adjust a length of a cylinder rod of the folding cylinder 133 through hydraulic pressure, so that the upper frame 132 is capable of standing upright by being pulled or is capable of being folded downward by being pushed.

An upper fixing frame 134 which is coupled to the upper frame 132 by a hinge such that a first side of the upper fixing frame 134 is capable of being rotated and which is configured to be brought into close contact with the upper surface of the electric bus is disposed on an upper side of the upper frame 132.

The upper fixing frame 134 may be connected to the upper frame 132 by the hinge such that the upper frame 132 has a predetermined length toward a front direction (a direction toward the electric bus) on the basis of a state in which the upper frame 132 stands upright. A lower surface of the upper fixing frame 134 is capable of being in close contact with the upper surface of the electric bus, and the upper fixing frame 134 may be formed such that the upper fixing frame 134 has a length long enough to reach a center portion of the battery disposed on the upper portion of the electric bus.

In addition, the upper fixing frame 134 is capable of being rotated in up and down directions from the upper frame 132 by an upper fixing cylinder 135, which will be described below.

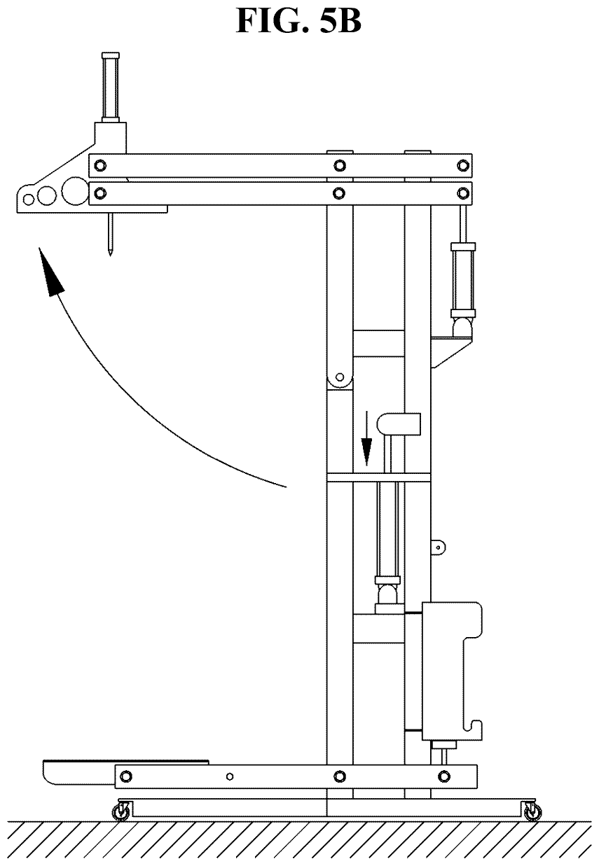

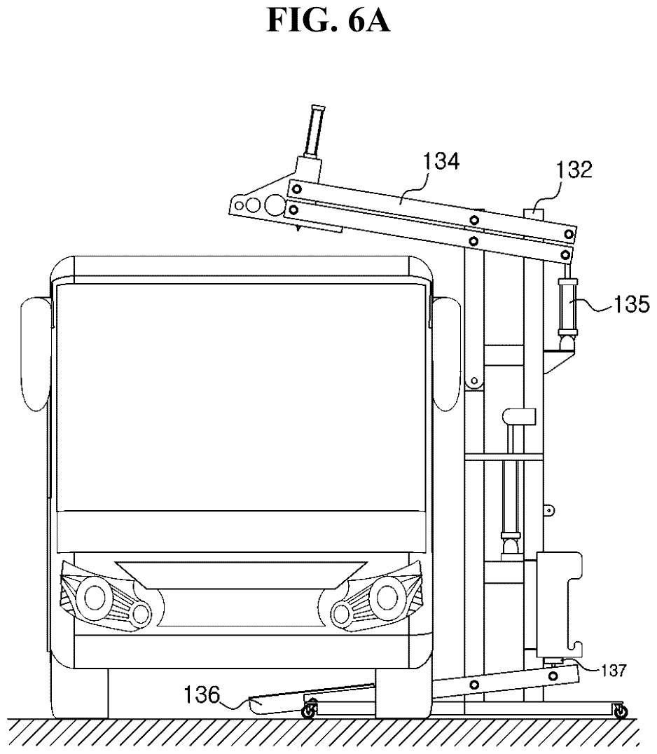

FIG. 6A and FIG. 6B are views illustrating a state in which the upper fixing frame 134 and a lower fixing frame 136 are respectively rotated from the upper frame 132 and the lower frame 131 by the upper fixing cylinder 135 and a lower fixing cylinder 137 and are respectively brought into close contact with the upper portion and the lower portion of the electric bus.

Referring to FIG. 6A and FIG. 6B, the upper fixing frame 134 and the upper frame 132 are connected to each other by the hinge, and the upper fixing frame 134 and the upper frame 132 are connected to each other by the upper fixing cylinder 135. A hydraulic cylinder is applied in the upper fixing cylinder 135. Therefore, the upper fixing cylinder may slightly pull up the upper fixing frame 134 upward by reducing a length of a cylinder through hydraulic pressure, or may bring the upper fixing frame 134 into close contact with the upper surface of the electric bus by pushing the upper fixing frame 134 downward by increasing the length of the cylinder.

That is, by pushing the upper fixing frame 134 downward through the upper fixing cylinder 135 after the upper fixing frame 134 is positioned above the upper surface of the electric bus in a state in which the upper fixing frame 134 is slightly pulled upward, the upper fixing frame 134 is brought into close contact with the upper surface of the electric bus. Therefore, the upper fixing frame 134 may serve to fix the foldable frame 130 to not be pushed or moved while the battery disposed on the upper portion of the electric bus is perforated by the lance 150 for spraying the fire-extinguishing water or while the process of spraying the high-pressure fire-extinguishing water is performed.

Such an upper fixing cylinder 135 is connected to the hydraulic pump 200 that is disposed on the first side of the transporting vehicle through the hydraulic pressure supply line, and may be controlled by hydraulic pressure.

The hydraulic pump 200 is connected to the upper fixing cylinder 135 through the high-pressure hydraulic supply line, and is configured to adjust a length of a cylinder rod of the upper fixing cylinder 135 through hydraulic pressure, so that upper fixing frame 134 is capable of being slightly pulled up or is capable of being pushed downward as the upper fixing cylinder 135 pushes the upper fixing frame 134, thereby being capable of bringing the lower surface of the upper fixing frame 134 into close contact with the upper surface of the electric bus.

In addition, the lance 150 for spraying the fire-extinguishing water that will be described later may be mounted on an end portion of the upper fixing frame 134 such that the lance 150 for spraying the fire-extinguishing water stands upright and faces downward. In a state in which the upper fixing frame 134 is in close contact with the upper surface of the electric bus, the lance 150 for spraying the fire-extinguishing water may perforate the battery disposed on the upper portion of the electric bus by using hydraulic pressure and then may spray the high-pressure fire-extinguishing water into the inner portion of the battery, thereby being capable of extinguishing the fire.

In addition, the lower fixing frame 136 and the lower frame 131 are connected to each other by a hinge, and the lower fixing frame 136 and the lower frame 131 are connected to each other by the lower fixing cylinder 137. A hydraulic cylinder is applied in the lower fixing cylinder 137. Furthermore, the lower fixing cylinder 137 may push an end portion of the lower fixing frame 136 downward by pulling the lower fixing frame 136 by reducing a length of the cylinder, or may pull the end portion upward by pushing the lower fixing frame 136 by increasing the length of the cylinder, thereby being capable of bringing the lower fixing frame 136 into close contact with the lower surface of the electric bus.

That is, by pulling the lower fixing frame 136 upward through the lower fixing cylinder 137 after the lower fixing frame 136 is positioned below the lower surface of the electric bus in a state in which the lower fixing frame 136 is slightly pushed downward, the lower fixing frame 136 is brought into close contact with the lower surface of the electric bus. Therefore, the lower fixing frame 136 may serve to fix the foldable frame 130 to not be pushed or moved while the battery disposed on the upper portion of the electric bus is perforated by the lance 150 for spraying the fire-extinguishing water or while the process of spraying the high-pressure fire-extinguishing water is performed.

Such a lower fixing cylinder 137 is connected to the hydraulic pump 200 that is disposed on the first side of the transporting vehicle through the hydraulic pressure supply line, and may be controlled by hydraulic pressure.

In addition, according to an embodiment, the upper fixing cylinder 135 and the lower fixing cylinder 137 may be controlled at the same time. For example, when hydraulic pressure is applied from the hydraulic pump 200 through the hydraulic pressure supply line connected to each of the upper fixing cylinder 135 and the lower fixing cylinder 137, the upper fixing frame 134 connected to the upper fixing cylinder 135 is lifted upward and the lower fixing frame 136 connected to the lower fixing cylinder 137 is lifted downward, so that the upper fixing frame 134 and the lower fixing frame 136 are splayed from each other.

In this situation, in a state in which the foldable frame 130 is moved such that the foldable frame 130 is positioned adjacent to the side surface of the electric bus in which the fire occurs, when a hydraulic pressure direction of the hydraulic pump 200 is switched into an opposite direction, the upper fixing frame 134 connected to the upper fixing cylinder 135 is moved downward toward the upper surface of the electric bus and the upper fixing frame 134 is in close contact with the upper surface of the electric bus, and the lower fixing frame 136 connected to the lower fixing cylinder 137 is moved upward toward the lower surface of the electric bus and the lower fixing frame 136 is in close contact with the lower surface of the electric bus.

That is, the upper fixing frame 134 and the lower fixing frame 136 become a narrowed state from the splayed state, and the foldable frame 130 tightens the upper and lower portions of the electric bus, so that the foldable frame 130 is capable of being solidly fixed to the electric bus accordingly.

In addition, a perforating cylinder 138 for perforating the battery by pushing the lance 150 for spraying the fire-extinguishing water toward the battery positioned on the upper portion of the electric bus may be disposed on the end portion of the upper fixing frame 134. This is described in more detail below.

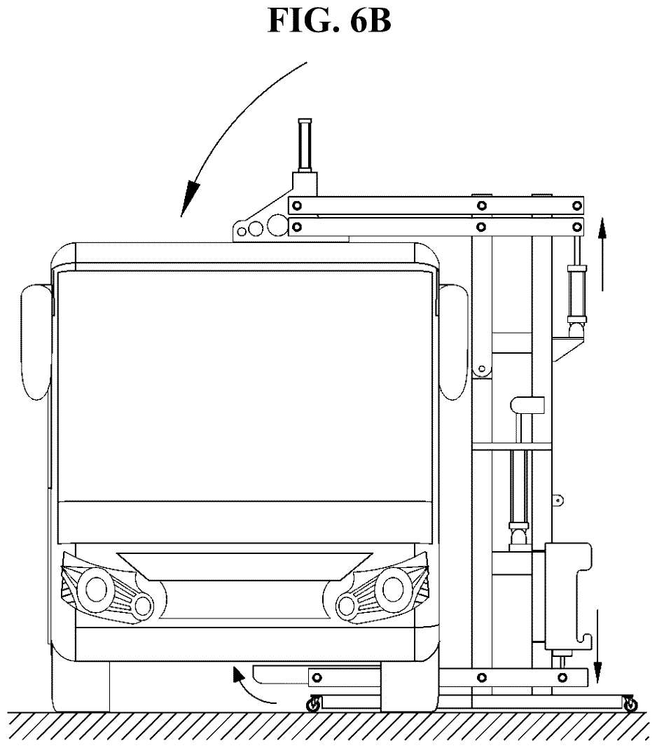

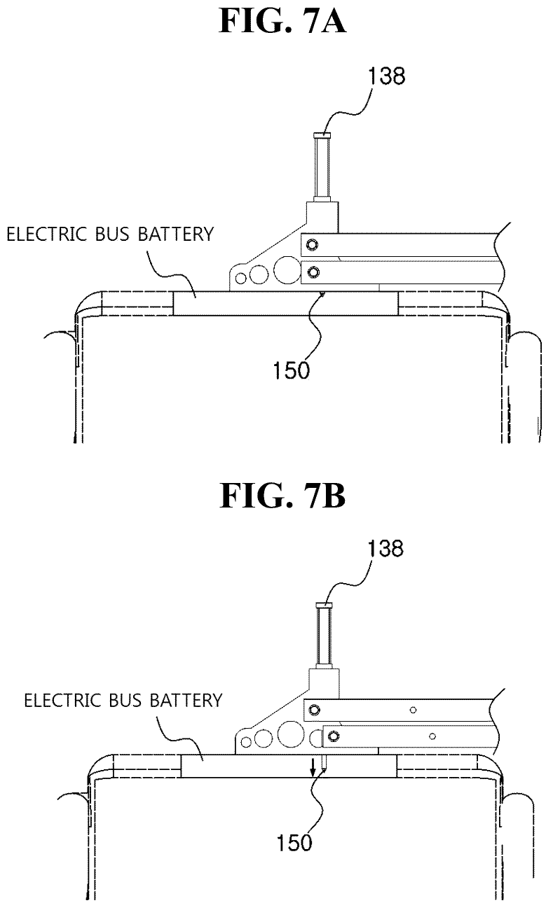

FIG. 7A and FIG. 7B are views illustrating a state in which the lance 150 for spraying the fire-extinguishing water is inserted toward the inner portion of the battery and perforates the battery by the perforating cylinder 138.

Referring to FIG. 7A and FIG. 7B, in a state in which the upper fixing frame 134 described above is in close contact with the upper surface of the electric bus through the upper fixing cylinder 135, a lower end of the lance 150 for spraying the fire-extinguishing water disposed in an upright state on the end portion of the upper fixing frame 134 is brought into close contact with the upper surface of the electric bus.

In this state, by moving the lance 150 for spraying the fire-extinguishing water downward through the perforating cylinder 138, the lance 150 for spraying the fire-extinguishing water is pushed downward by hydraulic pressure and perforates the battery. Such a perforating cylinder 138 is connected to the hydraulic pump 200 that is disposed on the first side of the transporting vehicle through the hydraulic pressure supply line, and may be controlled by hydraulic pressure.

At this time, the hydraulic pressure applied from the hydraulic pump 200 to the perforating cylinder 138 may correspond to a pressure sufficient for perforating the battery positioned on the upper surface and the inner portion the electric bus by using the lance 150 for spraying the fire-extinguishing water.

In a state in which the battery in the upper portion of the electric bus is perforated by the hydraulic pressure of the perforating cylinder 138 in this manner, the fire-extinguishing water is sprayed into the inner portion of the battery through a lower side of the lance 150 for spraying the fire-extinguishing water, so that fire extinguishing is started.

In addition, according to an embodiment, a locking round bar 131-1 for locking a locking ring 121-1 provided on an end portion of a cylinder rod 121 of the hydraulic cylinder 120 may be disposed on a first side of the lower frame 131. More specifically, the locking round bar 131-1 may be disposed on an upper portion of the lower frame 131 where the support stand 140 is mounted.

The locking round bar 131-1 may be locked on and coupled to the locking ring 121-1 provided on the end portion of the cylinder rod 121 of the hydraulic cylinder 120. Furthermore, the locking round bar 131-1 may be a point pulled during a process of loading the locking round bar 131-1 on the transporting vehicle by a locking coupling, or may be a point pushed during a process of unloading the locking round bar 131-1 from the transporting vehicle.

The support stand 140 is mounted on the first side of the lower frame 131 as described above, and may be slidably moved on the mounting round bar 112 during the unloading process while being in a state in which the support stand 140 is seated on the mounting round bar 112. This will be described in more detail below.

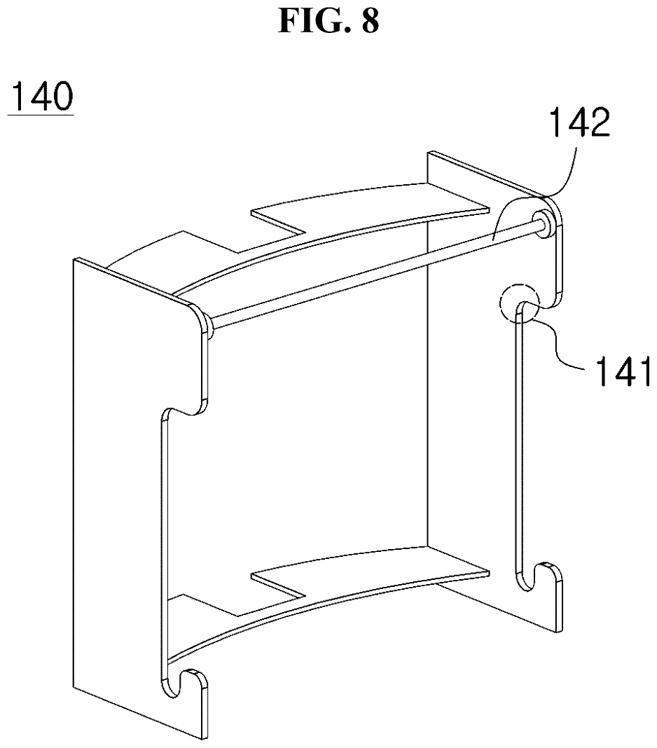

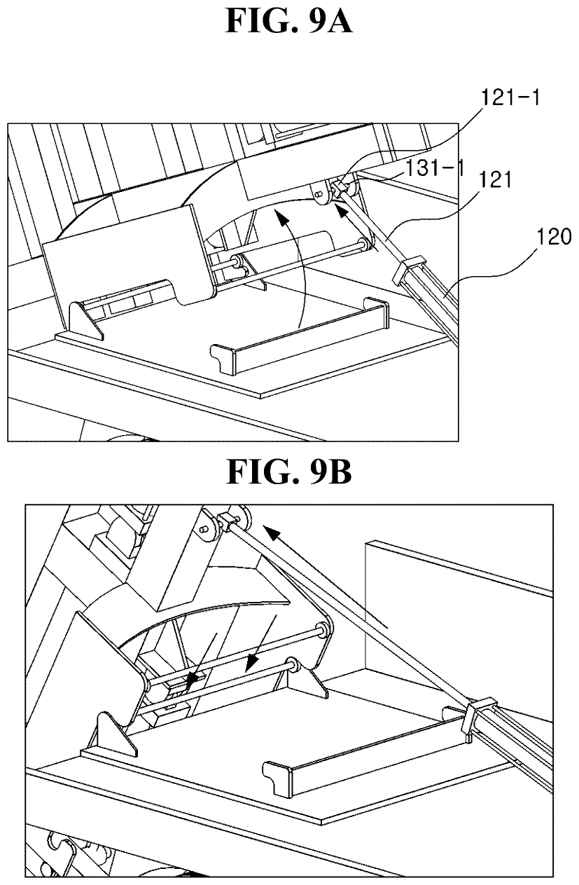

FIG. 8 is a view illustrating a configuration of the support stand 140 in more detail, and FIG. 9A and FIG. 9B are views illustrating a process in which the foldable frame 130 is unloaded from the transporting vehicle by pulling the cylinder rod 121.

Referring to FIG. 8, the support stand 140 may be positioned below the locking round bar 131-1 on the lower frame 131.

The first side of the support stand 140 may be seated on the mounting round bar 112 of the rotation assisting plate 110. As illustrated in FIG. 9A and FIG. 9B, when the cylinder rod 121 is pulled by the hydraulic pressure, the locking ring 121-1 provided on the end portion of the cylinder rod 121 pushes the locking round bar 131-1, so that the support stand 140 is pushed toward the rear side of the transporting vehicle while the support stand 140 is in a state in which the support stand 140 is seated on the mounting round bar 112.

In addition, a rotation locking step 141 for rotating the support stand 140 at 90 degrees by allowing the first side of the support stand 140 to be caught on the mounting round bar 112 during the process of sliding the support stand 140 on the mounting round bar 112 while the support stand 140 is in a state in which the support stand 140 is seated on the mounting round bar 112 is formed on the first side of the support stand 140.

The rotation locking step 141 has a structure in which the rotation locking step 141 is caught on the mounting round bar 112 while being in a state in which the support stand 140 is seated on the mounting round bar 112 and the support stand 140 is pushed as much as possible. At this time, the support stand 140 is naturally rotated at 90 degrees around the mounting round bar 112 as a rotary shaft by the weight of the foldable frame 130.

At this time, since the locking ring 121-1 provided on the end portion of the cylinder rod 121 is in a state in which the locking ring 121-1 is locked on and coupled to the locking round bar 131-1, the foldable frame 130 is not rapidly rotated but gradually rotated at 90 degrees, and the lower side of the foldable frame 130 is positioned close to the ground surface.

After the rotation is finished, the locking ring 121-1 is separated from the locking round bar 131-1, so that unloading of the foldable frame 130 is finished.

Conversely, in a situation in which the foldable frame 130 is loaded on the transporting vehicle, when the lower frame 131 is positioned adjacent to the rear side of the transporting vehicle and the locking ring 121-1 is locked on and coupled to the locking round bar 131-1, the cylinder rod 121 of the hydraulic cylinder 120 is pulled, so that the locking ring 121-1 pulls the locking round bar 131-1. Furthermore, in a state in which the rotation locking step 141 is caught on the mounting round bar 112, the support stand 140 is rotated upward at 90 degrees again.

In addition, as the locking ring 121-1 continuously pulls the locking round bar 131-1, the support stand 140 is slidably moved toward the inner side of the loading container of the transporting vehicle while the support stand 140 is in a state in which the support stand 140 is seated on the mounting round bar 112.

At this time, a rotation limitation round bar 142 configured to limit the rotation by being locked on and coupled to the locking and coupling mechanism 113 may be disposed on the first side of the support stand 140.

The rotation limitation round bar 142 is naturally locked on and coupled to the locking and coupling mechanism 113 having the “L” shaped cross-sectional area while the support stand 140 is seated on the mounting round bar 112 and the support stand 140 is slidably moved.

At this time, since the locking ring 121-1 is in a state in which the locking ring 121-1 is locked on and coupled to the locking round bar 131-1, the support stand 140 is solidly fixed to the rotation assisting plate 110 without being separated and rotated from the rotation assisting plate 110 as long as the locking ring 121-1 is not separated from the locking round bar 131-1.

The lance 150 for spraying the fire-extinguishing water may be mounted in a vertical direction on the end portion of the upper fixing frame 134 in the foldable frame 130. Furthermore, as the perforating cylinder 138 described above is disposed on the upper side of the lance 150 for spraying the fire-extinguishing water, the lance 150 for spraying the fire-extinguishing water is capable of forcibly perforating the battery positioned on the upper portion of the electric bus and then is capable of spraying the fire-extinguishing water into the inner portion of the battery by being moved downward when the perforating cylinder 138 is operated by the hydraulic pressure applied from the hydraulic pump 200. This is described in more detail below.

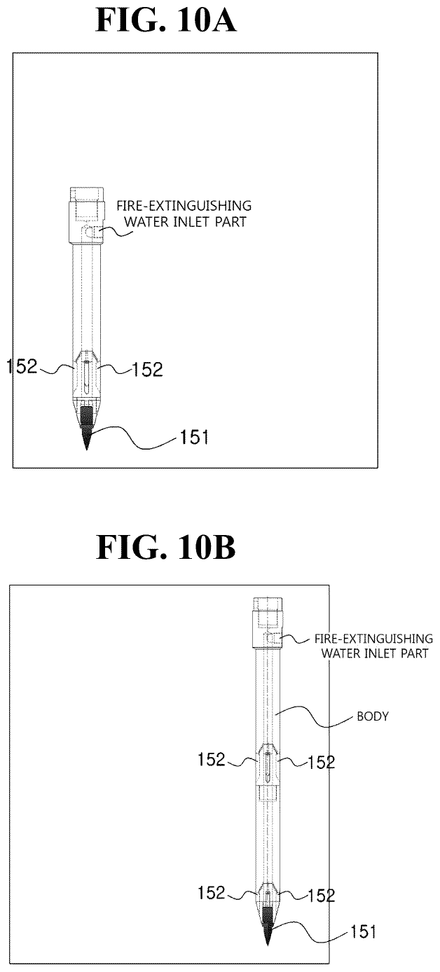

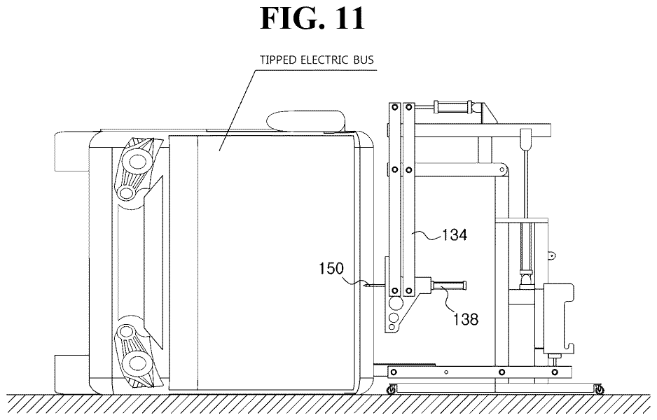

FIG. 10A and FIG. 10B are views illustrating the lance 150 for spraying the fire-extinguishing water in more detail.

Referring to FIG. 10A and FIG. 10B, the lance 150 for spraying fire-extinguishing water may include a lance head 151 which perforates and penetrates the upper portion of the battery by the hydraulic pressure and a fire-extinguishing water nozzle 152 formed on the side surface of a body of the lance 131 for spraying the fire-extinguishing water and configured to spray the fire-extinguishing water to the outside.

More specifically, the lance head 151 has a shape in which a lower end portion of the lance head 151 protrudes sharply, and may be formed of a material (for example, an alloy and so on) having a strength that is capable of easily penetrating an upper outer wall of the electric bus as well as the upper portion of the battery through the hydraulic pressure of the hydraulic pump 200. In addition, according to an embodiment, the lance head 151 may be connected to the lance 150 for spraying the fire-extinguishing water such that the lance head 151 is capable of being replaced from the lance 150 for the fire-extinguishing water. Therefore, when the performance of the lance head 151 is deteriorated since an end portion of the lance head becomes dull or the lance head 141 is partially damaged or deformed such that the lance head 151 does not well penetrate the upper portion of the battery, the lance head 151 may be replaced with a new lance head 151 from the lance 150 for spraying the fire-extinguishing water.

In addition, the fire-extinguishing water supply line may be connected to the side surface of the body of the lance 150 for spraying the fire-extinguishing water, and the fire-extinguishing water supply line may be connected to the fire-extinguishing water pump 300 connected to the fire-extinguishing water tank described above. Therefore, the fire-extinguishing water is capable of being strongly sprayed through the fire-extinguishing water nozzle 152 by the hydraulic pressure applied by the fire-extinguishing water pump 300.

At this time, as illustrated in FIG. 10(b), the body of the lance 150 for spraying the fire-extinguishing water may be formed as a multi-stage body, and the fire-extinguishing water nozzle 152 may be disposed on the side surface of each stage of the body.

In addition, an internal supply line for injecting the fire-extinguishing water supplied through the fire-extinguishing water supply line may be formed inside the lance 150 for spraying the fire-extinguishing water.

In addition, according to an embodiment, since the perforating cylinder 138 and the lance 150 for spraying the fire-extinguishing water are configured such that a direction of the perforating cylinder 138 and the lance 150 for spraying the fire-extinguishing water are capable of being switched by releasing a bolt from the end portion of the upper fixing frame 134, so that the perforating cylinder 138 and the lance 150 for spraying the fire-extinguishing water can perforate the battery of the electric bus from a side direction when the battery of the electric bus is not positioned upward but positioned in the side direction due to the electric bus that is tipped sideways. This is described in more detail below.

FIG. 11 is a view illustrating a state in which the lance 150 for spraying the fire-extinguishing water is inserted toward the inner portion of the battery and perforates the battery from a side surface of the electric bus that is tipped sideways.

Referring to FIG. 11, when the electric bus in which a fire occurs is tipped sideways and the battery does not face upward but in the side direction, the direction of the perforating cylinder 138 and the lance 150 for spraying the fire-extinguishing water are switched at 180 degrees by releasing the bolt of the end portion of the upper fixing frame 134, so that the lance 150 for spraying the fire-extinguishing water may face the battery of the electric vehicle. In this state, the lance 150 for spraying the fire-extinguishing water perforates and penetrates the battery by the hydraulic pressure. Furthermore, in a state in which the battery of the electric bus is perforated, the fire-extinguishing water is sprayed into the inner portion of the battery through the lower side of the lance 150 for spraying the fire-extinguishing water, thereby starting fire extinguishing.

In the present disclosure, the present disclosure is described in relation to some embodiments, but various modifications and changes can be made within the scope without departing from the scope of the present disclosure that can be understood by those skilled in the art in the present disclosure. Furthermore, the modifications and the changes should be regarded to be included in the appended claims of the present disclosure.

What is claimed is:

1. An electric bus fire extinguishing apparatus capable of being loaded and unloaded by a hydraulic cylinder, the electric bus fire extinguishing apparatus comprising:
a rotation assisting plate (110) mounted on a rear side of a loading container of a transporting vehicle;
a hydraulic cylinder (120) disposed in the loading container of the transporting vehicle;
a foldable frame (130) configured to be unfolded and folded by hydraulic pressure;
a support stand (140) disposed on a first side of the foldable frame (130) and configured such that a first side of the support stand (140) is locked on and coupled to an end portion of a cylinder rod (121) that is pulled from the hydraulic cylinder (120); and
a lance (150) for spraying fire-extinguishing water, the lance (150) being disposed on the foldable frame (130), and the lance (150) being configured to perforate a battery disposed on an upper portion of an electric vehicle and to spray the fire-extinguishing water supplied from a fire-extinguishing water tank mounted in the transporting vehicle into an inner portion of the battery,
wherein, in a state in which the support stand (140) is locked on and coupled to the end portion of the cylinder rod (121), the support stand (140) is seated on the rotation assisting plate (110) and a state in which the support stand (140) is loaded on the transporting vehicle is maintained, and
wherein, when the cylinder rod (121) is pulled, the support stand (140) is moved toward a ground surface by being slidably moved while the support stand (140) is in a state in which the support stand (140) is in close contact with the rotation assisting plate (110), and the support stand (140) is released from the end portion of the cylinder rod (121), so that the support stand (140) and the rotation assisting plate (110) are separated from each other and then unloading is finished.

2. The electric bus fire extinguishing apparatus of claim 1, wherein the rotation assisting plate (110) comprises:
a base plate (111) disposed on a rear side of a bottom surface of the loading container;
a mounting round bar (112) which is disposed on an upper side of the base plate (111) and on which the support stand (140) is mounted; and
a locking and coupling mechanism (113) disposed on the upper side of the base plate (111) such that the locking and coupling mechanism (113) is spaced apart from the mounting round bar (112) by a predetermined distance, the locking and coupling mechanism (113) being configured such that the first side of the support stand (140) is locked on and coupled to the locking and coupling mechanism

(113) while the support stand (140) is in a state in which the support stand (140) is seated on the mounting round bar (112).

3. The electric bus fire extinguishing apparatus of claim 2, wherein the foldable frame (130) comprises:
a lower frame (131);
an upper frame (132) to the lower frame (131) by a hinge such that a first side of the upper frame (132) is capable of being rotated;
a folding cylinder (133) connected to the lower frame (131) and the upper frame (132) by being positioned between the lower frame (131) and the upper frame (132), the folding cylinder (133) being configured to control a rotation of the upper frame (132) by hydraulic pressure;
an upper fixing frame (134) coupled to the upper frame (132) by a hinge such that a first side of the upper fixing frame (134) is capable of being rotated, the upper fixing frame (134) being configured to be brought into close contact with an upper surface of the electric bus;
an upper fixing cylinder (135) connected to the upper frame (132) and the upper fixing frame (134) by being positioned between the upper frame (132) and the upper fixing frame (134), the upper fixing cylinder (135) being configured to control a rotation of the upper fixing frame (134) by hydraulic pressure;
a lower fixing frame (136) coupled to the lower frame (131) by a hinge such that a first side of the lower fixing frame (136) is capable of being rotated, the lower fixing frame (136) being configured to be brought into close contact with a lower surface of the electric bus;
a lower fixing cylinder (137) connected to the lower frame (131) and the lower fixing frame (136) by being positioned between the lower frame (131) and the lower fixing frame (136), the lower fixing cylinder (137) being configured to control a rotation of the lower fixing frame (136) by hydraulic pressure; and
a perforating cylinder (138) disposed on an end portion of the upper fixing frame (134), the perforating cylinder (138) being configured to push the lance (150) for spraying the fire-extinguishing water positioned above the electric bus toward the battery.

4. The electric bus fire extinguishing apparatus of claim 3, wherein the folding cylinder (133), the upper fixing cylinder (135), the lower fixing cylinder (137), and the perforating cylinder (138) are connected to a hydraulic pump (200) disposed on a first side of the transporting vehicle through a hydraulic pressure supply line, and are controlled by hydraulic pressure.

5. The electric bus fire extinguishing apparatus of claim 3, wherein the support stand (140) is disposed on a first side of the lower frame (131), has a predetermined length, and is configured to be slidably moved on the mounting round bar (112) while being in a state in which the support stand (140) is seated on the mounting round bar (112).

6. The electric bus fire extinguishing apparatus of claim 5, wherein the support stand (140) comprises:
a rotation locking step (141) for rotating the support stand (140) at 90 degrees by allowing the first side of the support stand (140) to be caught on the mounting round bar (112) during a process of sliding the support stand (140) on the mounting round bar (112) while the support stand (140) is in a state in which the support stand (140) is seated on the mounting round bar (112) while the unloading is performed; and
a rotation limitation round bar (142) configured to be locked on and coupled to the locking and coupling mechanism (113) so as to prevent the rotation of the support stand (140) while loading is performed.

7. The electric bus fire extinguishing apparatus of claim 1, wherein the lance (150) for spraying the fire-extinguishing water is configured to receive the fire-extinguishing water by being coupled to a fire-extinguishing water pump (300) disposed on a first side of the fire-extinguishing water tank through a fire-extinguishing water supply line.

8. The electric bus fire extinguishing apparatus of claim 7, wherein the lance (150) for spraying the fire-extinguishing water comprises:
a lance head (151) configured to perforate an upper portion of the battery by hydraulic pressure; and
a fire-extinguishing water nozzle (152) formed on a side surface of a body of the lance (150) for spraying the fire-extinguishing water, the fire-extinguishing water nozzle (152) being configured to spray the fire-extinguishing water to the outside, and
wherein the lance head (151) is connected to the lance (150) for spraying the fire-extinguishing water such that the lance head (151) is capable of being replaced from the body of the lance (150) for spraying the fire-extinguishing water.

9. The electric bus fire extinguishing apparatus of claim 8, wherein the body of the lance (150) for spraying the fire-extinguishing water is formed as a multi-stage body, and the fire-extinguishing water nozzle (152) is disposed on each stage of the body.

10. The electric bus fire extinguishing apparatus of claim 3, wherein the perforating cylinder (138) and the lance (150) for spraying the fire-extinguishing water are configured such that a direction of the perforating cylinder (138) and the lance (150) for spraying the fire-extinguishing water is capable of being switched by releasing a bolt from the end portion of the upper fixing frame (134).
